(19) United States
(12) Patent Application Publication
(10) Pub. No.: US 2021/0054515 A1
(43) Pub. Date: Feb. 25, 2021

(54) ELECTROCHEMICAL REACTOR FOR PROCESSES FOR NON-FERROUS METAL ELECTRODEPOSITION, WHICH COMPRISES A SET OF APPARATUSES FOR GENTLY AGITATING AN ELECTROLYTE, A SET OF APPARATUSES FOR CONTAINING AND COALESCING AN ACID MIST, AND A SET OF APPARATUSES FOR CAPTURING AND DILUTING ACID MIST AEROSOLS REMAINING IN THE GAS EFFLUENT OF THE REACTOR

(71) Applicant: Victor Eduardo VIDAURRE HEIREMANS, Santiago (CL)

(72) Inventor: Victor Eduardo VIDAURRE HEIREMANS, Santiago (CL)

(21) Appl. No.: 16/982,865

(22) PCT Filed: Mar. 21, 2019
(86) PCT No.: PCT/CL2019/050018

§ 371 Date: Sep. 21, 2020

(30) Foreign Application Priority Data
Mar. 22, 2018 (CL) 757-2018

(51) Int. Cl. C25C 7/06; C25C 1/00; B01D 47/00; B01F 13/02

(52) U.S. Cl. CPC C25C 7/06; B01F 13/0255; B01D 47/00; C25C 1/00

(57) ABSTRACT

The invention relates to an electrochemical reactor for continuous copper electrodeposition at high current densities with copper sulfate electrolytes, which comprises devices and systems of functional means that are linked and operated in line, thereby forming a “triad”, for standardising operational conditions in a series of operative parallel reactors. The triad, installed in each existing or new electrolytic container, comprises: a gentle electrolyte agitation system (AGSEL) with means for pulsing control of the aeration volume diffused by bubbling directed into each inter-cathodic space; a “duo” of systems linked in line, which comprises a system of removable anode covers (CAR) for containing, confining and coalescing the acid mist; and an acid mist recycling system (SIRENA) that captures non-coalesced electrolyte aerosols and condenses the steam, returning same to the process, while the pollutants of the gaseous fluid from the reactor are substantially diluted.

### TECHNICAL FIELD OF THE INVENTION

The conduction of electrolytic processes for electrowinning nonferrous metals with lead anodes cells from sulfurous solutions in electrolytic, since the beginning of its scientific dissemination by Michael Faraday (1833), the main operational limitations of the process of electrowinning metals, have been, and still continue to be:

Inhomogeneous transfer of ionic mass, from the electrolyte to the surfaces of cathodic plates in the interelectrode spaces; and smooth, uniform compaction of deposits when operating the electrodeposition process of non-ferrous metals above its so called “limit current density”; in this condition, the process variables begin to lose the equilibriums with which acceptable deposit results are uniformly achieved, and objectionable defects and physical quality impairments of the metal plates begin to become aleatory generalized with as degraded chemical composition due to the presence of electrolyte impurities electrodeposited together with the metal.

Generation of acid mist due to the inevitable generation of anodic oxygen electrochemical decomposition of water in the electrolyte aqueous solution, according to the intensity of the direct current that passes through “insoluble” anode plates.

In prior art of the copper electrowinning processes, over time several solution strategies for each of these limitations have been proposed separately, since they represent—in each “electrolytic cell”—two different problems caused by the current intensity in the same electrochemical process; such as, on the one hand, the control and mitigation of the acid mist generated effluent, and on the other, improving at high current densities—sustained and consistently over time—the transfer of ionic mass from the electrolyte to the cathodes plate, simultaneously with homogeneous compact adhesion of the metal, from the beginning to the end of each electrodeposition cycle.

Until the present invention, both electrochemical limitations of the process have not been fully and definitively resolved simultaneously and sustainably, “as and where” these limitations originate, that is, in such a way as to enable the industrial operation of the electrowinning process at high current intensities, in permanent and stable, predictable, sustainable and “environmentally friendly manner”, with substantial decrease in acid mist generation, and taking advantage of favorable synergies existing in the actual environment of the process, which until now, have not been exploited either; on the one hand, to increase both productivity and quality simultaneously with chemical and physical electrodeposition of metal cathode plates; and on the other, to recover/recycling electrolyte aerosols, water vapor, acid; but above all, to be able to reduce, substantially and simultaneously, the consumption of energy (thermal and electrical) and water, to minimum levels compared to the consumption of current art.

In this invention, we understand by “electrolytic cell”, the electrochemical arrangement of each pair of vertical and parallel surfaces of “anodes-cathodes”, arranged facing each other at a fixed distance—which we call “unit cells”—; the “unit cells”, therefore, although they share a common electrolyte volume with a plurality of successive unit cells installed in the same electrodeposition container, in practice they DO NOT operate at the same current density despite the fact that each container—named “electrolytic cell” in current art—is powered by a stable current intensity. The above condition depends, among others, on the quality of the electrical contacts of each unit cell with the current bar of the container, and other physical conditions, which generate operational problems outside the scope of this invention.

The solutions proposed in this invention provide within a single electrolytic container different synergic sets of equipment and additional means to the unit cells in their container, designed ad-hoc to overcome each limiting problem with their respective coordinated online operation, so that both limitations are simultaneously overcome together with the operation of the process in the electrochemical reactor.

In the first place, the first limiting indicated, is a direct function of the intensity of current operated, and is determined according to the First Law of Faraday. Theoretical amount of electroplated metallic copper per reactor is calculated with Equation 1 below:

$$m = \frac{M * i * A * t}{z * F} \qquad ( Equation 1 )$$

Where: m is the mass of electrodeposited copper in g, M is the molar mass of copper in g/mol, i is the current density in A/m², A is the area of cathodic electrodeposition in m² per reactor, t is the operating time in s, z is the valence of the ions involved in the electrochemical reaction and F is the Faraday constant in A/mol.

From this equation, it follows that, if it is desired to increase the amount of electroplated copper with a given reactor size, the increase in production can be achieved, among others, by increasing the current intensity, and also, by correcting other factors, such as example, the verticality of electrodes, decreasing the content of Fe⁺³ ion in electrolyte, among others.

According to U.S. Pat. No. 8,454,818 B2, the current art industrial electrolytic cell performance uses only about 30 to 40% of the theoretical limit current intensity i_{Limit}.

$${i}_{Limit} = n * F * D * \frac{{C}^{0}}{{δ}_{N}} theoretical \qquad ( Equation 2 )$$

This intensity i_{Limit} (in Equation 2) is a function of the concentration of copper ions in the electrolyte (C⁰) and the thickness of the diffusion layer δ_{N} at the cathodes. Note that, N, is the number of ions involved in the process, F, the Faraday constant and D, the diffusion coefficient, which are all constant.

The calculation of performance at the theoretical limit current density, according to the same above patent, gives values of approximately 1000 A/m² as a theoretical maximum; with equipment configurations and other limiting industrial practices of current art, industrial current densities only reach about maximum 300-350 A/m².

However, sustained industrial operation at current intensities at substantially higher than those of the current art, brings with it inevitable unique occurrences of dendritic formations in the electrodeposit, whose accelerated preferential growth ends up generating severe electrical short circuits, which represent significant risks of operational and safety incidents, which also reduce both electrical efficiency and electrodeposited cathodic quality.

The industrial challenge of increasing the productivity of the electrowinning process without compromising quality and excessive electrical consumption, essentially translates into reducing the thickness of the Nernst diffusion layer in the vicinity of the cathodes; which in turn requires the implementation of a strategy with hydrodynamic means to increase in a sustained and controlled manner the relative movements between the electrolyte and the electrodes as in the present application.

In this invention, it is proposed to achieve the aforementioned by incorporating an Electrolyte Soft Agitation System “AGSEL”⁽¹⁾ based on the directed and controlled diffusion of rows of air bubbles of uniform characteristics, in each unit cell, in precise diameter, flow and pressure ranges to provide ad-hoc soft agitation with bubbling patterns of bubble sizes and sequences and other characteristics so that, by superimposing the diffusion of ad-hoc flows of controlled bubbles of external air to the “random natural agitation” of the electrolyte with O2 bubbles generated in the surface of the energized anodes, as a whole, generate the effective relative movements—between the electrolyte and the cathodes—to optimize the homogeneity of ion mass transfer in each unit cell, managing to sustain a higher speed of electrodeposition with optimal quality and electrical efficiency at operation with the high current intensities desired industrially.

At the same time, this invention further provides synergic sets of CAR⁽²⁾ and SIRENA⁽³⁾ Systems with means functionally concatenated to the overall flow rate of air bubbles that diffuse into the electrolyte for substantial decrease of inline acid mist at the current intensities to be operated. To overcome the second limitation, CAR+SIRENA use the natural O₂ bubbling flow of the anodes, suitably modified by the flow rates of the complementary controlled aeration provided by AGSEL, which is directed towards the intercathode spaces of the unit cells to enhance the transfer promotion ionic mass to operated current density.
(1) “AGSEL”—abbreviation for “Electrolyte Soft Agitation System” in Spanish
(2) “CAR”—abbreviation for “Removable Anodic Covers” in Spanish
(3) “SIRENA”—abbreviation for “Acid Mist Recycling System” in Spanish

In short, with the simultaneous operation of the CAR and SIRENA with their operational variables duly adjusted to complement the anode O₂ flow rate resulting from the actual current density operated, and with additional ad hoc bubbles of external electrolyte agitation air, it has been proven possible to sustain continuously balanced over time up to seven simultaneous operations on each of the unit cells of the container operated at high current densities; and also with a simultaneous substantial decrease in the resulting acid mist: the first four on-line operations are completed with the CAR System inside the container: “contain”, “confine”, “coalesce” and “recycle”, representing the abatement of a substantial portion of the acid mist flow at the same time that it is generated; and the remaining three operations in line refer to the flow of the gaseous fluid effluent outside of the electrolytic container with the SIRENA System, installed on one of the front walls of the container to “capture”, “condense” and “dilute” the level of contaminants in the gaseous fluid effluent from the container; as required by applicable environmental sustainability standards. In this invention, it is optional to continue the depuration of the effluent gaseous fluid until achieving a required safety level is achieved before being discharged to open atmosphere; but always the depuration includes capture, and recovery of electrolyte aerosols and water vapor and acid contained in the effluent gaseous fluid flow extracted from the reactor before discharging in open atmosphere.

The controlled operation of Copper electrowinning process gained by incorporating the systems of the present invention, in fact, converts the so-called “electrolytic cell” of current art, properly speaking, into the “electrochemical reactor” proposed in this invention; that is, a suitable container of current art supplied to take advantage of the unique synergistic contribution provided by thermal conservation provided by the same installation of the CAR roofing system to “contain”, “confine” and “coalesce” and “recycle” the acid mist; in fact, CAR together with retaining the electrolyte inside the container of each electrochemical reactor, also avoids the evaporation of water and loss of acid into the atmosphere of the electrolyte fed at temperatures of 45-50° C., because the removable anode covers provide insulation thermal to the contents inside the container of the coldest external environment. In particular, the thermal temperature gradient of the electrolyte is decreased in its passage from the infeed end of the container to the overflow end, maintaining the most uniform temperature on the immersed surfaces of the cathodes in operation in each unit cell, singularly favoring homogeneity of transfer of ionic mass in the intercathode spaces of the electrochemical reactor.

Summing up, the proposed invention overcomes the two historical limitations of the current art electrodeposition process, simultaneously, jointly and sustained over time in each unit cell together with its operation; and with this, “each container that install a plurality of unit cells” begins to function as an “electrochemical reactor”; and the plurality of “reactors” operated simultaneously with common process variables, constitute the “cell banks” that form an industrial plant of current art.

The concept of “unit cell” approach—which we call cell by cell—should be understood as “unit cell” to “unit cell”, which is simultaneous and synergistic in time for each limiter, and is embodied in the present invention as: “each electrochemical reactor at high current densities has incorporated the equipment and ad hoc means necessary to simultaneously and sustainably perform 2 additional functions to electrode position: substantially decrease the flow rates of its own acid mist at the same time that it is generated, and recover the condensates of the acid mist recycling them to the EW process that originated them”.

### PREVIOUS ART

From the revision of the U.S. Pat. No. 1,032,623 granted in 1912 to C. J. Reed, where he proposes an alternative conduction of the electrodeposition process with extraction of the usable anodic gas by means of a first electrode provided with a mini O₂ sensor chamber, originally, the “cell by cell” concept of solution to the problem of acid mist arose. Reed's goal—removal of the anode gas—is accomplished “anode by anode” in the process operation itself. Reed's “simultaneity” triggered—100 years later—the “unitary” solution approach at the same point of generation to substantially decrease the limiting “acid mist” proposed in this invention; This has required the development, materialization and validation of “ad hoc unit media” arranged, in up to seven successive simultaneous online operations, until the acid mist and its contamination are substantially reduced to levels with the operation of the electrochemical process itself.

Indeed, the anodic bell “ad hoc” of C. J. Reed has pioneered the concept “incorporation of a non-invasive anode-to-anode cover”—as a device or unit medium—to achieve—in a first stage—the specific purpose of substantially reducing acid mist in the same container—in simultaneously and jointly—with the normal operation of the electrolytic process: the mist is lowered at the same time that it is generated.

The acid mist effluent gaseous fluid generated by the continuous operation of the electrochemical reactor is immediately depurated, subsequently decreasing it substantially in a second in-line stage, at the container outlet, with the simultaneous operation of the Acid Mist Recycling System (SIRENA)—described in U.S. Pat. No. 9,498,745 (2016), and INAPI CL 55.012-2017 (patent application CL 2013-1789)—on the same exterior front wall of the container through which the effluent gaseous fluid is extracted.

On the other hand, it should be noted that the successful materialization and validation of the “cell by cell” solution methodology applied to the acid mist of the present invention was carried out in parallel during the 10 years of introduction of the Electrolyte Soft Aeration System to improve the transfer of copper ionic mass to the cathodic plates of the electrowinning process of the current art; In these circumstances, the technological development of the substantial decrease in acid mist from the electrowinning process was enriched by having in view the operational experience and results of the other innovation, with its many “lessons learned”, necessary to successfully materialize its continuous stable industrial operation.

### Previous Art—First Limitation: Ionic Mass Transfer

The general electrolysis equation indicates what happens chemically in the electrowinning of copper: CuSO4+H₂O→Cu^{o}+½O₂+H2SO4 and the following is deduced:

1 mole of Sulfate (CuSO4) generates 1 mole of O, or ½ mole of O₂ or, 1 mole of electroplated Cu generates 1 mole of O, or ½ mole of O₂.

This is equivalent to:

63.54 gr of Cu deposited generate 16 gr of O₂, which means that the generation of →Oxygen is 0.2518 gr of O₂ for each gr of Cu deposited.

According to Faraday Equation 1, the copper deposit is proportional to the circulating current intensity (Amperes). To operate a standard 60-cathode cell of the current art at 300 A/m², a current intensity of 36,000 A is required. To operate at current intensities raised above 400-450 A/m², 48,000 A to 54,000 A is required, with which It generates between 25% and 50% more acid mist flow rate than at 300 A/m².

The homogeneity in the transfer of ionic mass achieving its adhesion to the cathode plates depends, substantially, on having a sufficient concentration of mass of metal ions available in the electrolyte solution, and on its temperature, a variable that is critical in the boundary layer of the cathodes; so that by maintaining an abundant stock of ionic mass ready available for electrodeposition, it is possible to effectively deposit metal ions on the cathode plate according to the intensity of the current operated. To achieve and sustain said stable conditions over time, the hydrodynamic condition of the flow rate of infeed and distribution of the electrolyte inside the container is very important; in particular, the location of the discharge points in the container and the resulting hydrodynamics of the electrolyte with respect to the electrodes. For example, to improve the mass transfer of metal ions in copper electrodeposition cells of the current art, the industry has adopted the use of forced feeding of the electrolyte through a “tuning fork” type system. The “tuning fork” configures the supply of the electrolyte inside the container, by means of an inlet pipe attached vertically on the inside to one of the front walls of the container, which extends from the edge to the bottom of the container; from there, by means of a “T”, the vertical pipe is connected with two orthogonal pipes directed towards the side walls; which by means of 90° curved elbows, both infeed pipes extend parallel lengthwise, a short distance from the container floor, for the entire length of both side walls. The electrolyte infeed of the “tuning fork” is made up of both horizontal sections close to the floor, provided with rows of ad hoc spaced holes and of appropriate diameters to discharge the electrolyte in continuous trickles from each hole, on both surfaces at the top of the “tuning fork”, pointing towards the center of the interelectrode spaces, at an angle of 45° with respect to the vertical.

For more than a decade, industrial practice in copper electrodeposition has recognized that, in order to increase the productivity of the process with higher current intensities without reducing the quality of the electrodeposition, it is necessary to improve, in parallel, the conditions for the transfer of ionic mass to cathode plates. The feeding of the electrolyte under hydraulic pressure to the container is limited by the unfavorable turbulences generated by the discharge of electrolyte jets at excessive pressures into the interelectrode spaces of the unit cells, and with this, the transfer is hindered to achieve the necessary homogeneity and adhesion with good flatness of metal compaction in all copper electrodeposits in all cathode plates.

The insufficiencies in the transfer of ionic mass to the cathode plate and non-uniformities of deposit at current intensities of the current art—which the same inventor disclosed in patent applications CL 2009-893 and CL 2011-2661—are incorporated as precedents in the present invention patent application—and are now resolved by introducing radical configuration and capability improvements to extend and improve the benefits for continuous operation at substantially high current intensities which have not been developed in this technical field to date.

A functional improvement validated in the state of the art was the installation of a system for external, orthogonal and horizontal air diffusion—over the “tuning fork”- and below the electrodes; The stable flow at controlled pressure of the system dosages air flows in the form of rows of small rising bubbles in the electrolyte, from its diffusing isobaric ring near the bottom of the container to provide “soft agitation” throughout the bulk of the container electrolyte. In the interelectrode spaces of the unit cells, the upward flow of agitation air bubbles is mixed and added to that of the “natural” O₂ bubbles of the process that emerge randomly from the anodes; when mixed together they rise by their own buoyancy, and both are driven by the flow of the electrolyte feed flow forced by hydraulic pressure from the tuning fork; the rising gas volume, increased by both bubbles, sweep the cathodic and anode surfaces in each unit cell. Indeed, hydrodynamics in the intercathode spaces is enhanced, first, by the force-feeding effectiveness of the bulk of the rich electrolyte mass directed from the holes of the “tuning fork” towards the centers of the interelectrode spaces; and then, adding the contribution additional soft turbulence provided by the mixing air bubble flow rates mixed with the natural O₂ bubbles in their sweep of the cathodic electrodeposition surfaces; These two correctly combined effects homogenize the movement of copper ion mass transfer and shorten the distance from the boundary layer to the cathodic surfaces. At the current intensities of current art, the result is a matching and compaction of the thickness of the metal deposit on the plates, significantly reducing nodulations. The improvement in the effectiveness and efficiency in the transfer of ionic mass must be sustained simultaneously in each intercathode space to substantially increase productivity in all the “unit cells”, improving the overall electrical efficiency of the process. The stable achievement of this key effect allows the current density supplied to each anode of the “anode—cathode” pair to be maintained at 280-300 A/m² in the current art. The flatness characteristics, thickness uniformity of the metal plates, surface smoothness with minimal nodulation in the respective electrodeposits, in turn, visibly improve—and therefore—also the chemical purity of copper in each “unit cell”. (See CODELCO Publication—Gabriela Mistral Division, Minera Gaby, by Francisco Sanchez Pino in Copper 2013, attached)

Note: The disclosed experience was achieved, with the current intensity available at the Minera Gaby EW Plant, simply by removing a number of cathode plates from the experience cells, which operated at higher current density with the same current intensity at the Plant.

The electrolyte aeration systems described correspond to the devices and configurations disclosed in patent applications CL 2009-893 and CL 2011-2661 by the same inventor. The Electrolyte Soft Aeration Systems of the indicated technology were not intended—nor were they designed—to overcome the limitation of ion mass transfer above 280-300 A/m².

Therefore, the indicated systems of soft aeration of the electrolyte of the current art suffer from insurmountable limitations of capacity—flow and pressure—and cannot be overcome by the diffusion of air fed by means of an isobaric diffuser ring or other means (isobaric diffuser ring also generator other functional and operational problems), and above all, due to the longitudinal arrangement of the diffusers parallel to the central axis of the container, which were designed to discharge bubbles into the bulk of the electrolyte, and specifically, do not deliver the rows of directed bubbles in the intercathode spaces where they are essential. These limitations do not guarantee benefits if the industrial EW process is to be operated continuously at currents above 330-350 A/m² upwards.

### More References are Found in the Following INAPI Registers:

### Patent Application 2009-893

Self-supporting isobaric structure formed by a hollow structural frame made of three materials over a hollow thermoplastic core covered with layers of resin saturated glass fiber blankets, which are covered with a thermoset polymeric composite material, forming a monolithic resistant structural compound.

### Patent Application 2011-2661

Method of operation of gas bubble diffuser system comprising range of: a) gas flow referred to each cathode between 0.2-1.7 lpm per cathode and/or, b) gasification rate referred to electrolyte volume, c) gauge pressure of the gas flow, d) range of gas pressure drop, e) gas flow rate; and diffuser system.

The AGSEL System in the present application has been embodied with a transverse arrangement of the smooth agitation diffuser tubes—parallel to the anodes and cathodes of each unit cell—specifically addressed to bubble in the interelectrode space of each unit cell of the electrochemical reactor. In the current art, the diffuser tubes are arranged longitudinally and coupled to the diffuser ring, whose maximum flow rate is limited by the practical maximum 14-15 diffuser tubes parallel to the longitudinal axis of the electrochemical reactor in the typical widths of the industrial containers of the current art.

To accompany the increases in acid mist flow generated with the high currents intensities at which it is intended to operate, it is required to increase the aeration flow of the current art electrolyte agitation systems from 25 to 50%, and accordingly, the total footage of smooth agitation diffuser tubes; this range of flow increase is impossible to achieve with a longitudinal arrangement of diffuser tubes in their isobaric diffuser ring.

### Previous Art—Second Limitation: Substantial Decrease of Acid Mist

Regarding the second limitation—substantial decrease in acid mist —, the volumes of oxygen (O₂) generated in current industrial electrowinning processes for copper and other non-ferrous metals are directly proportional to the current intensities applied to the anodes, and consequently, to the environmental contamination associated with the operation of the electrowinning cells of the current art. As noted, O₂ gas is given off randomly in the form of individual bubbles of undetermined size from the surfaces of the flat faces of the anode plates; bubbles rise to the surface of the electrolyte; and together with emerging into the atmosphere, they explode by pressure differential, with which their interfaces are divided into liquid micro particles forming aerosols of electrolyte (sulfuric acid) that are incorporated into the gaseous fluid of O₂ emerging from the anodes, together with vapor of water (and if the electrowinning process already has soft agitation of the electrolyte, also air) in the electrolyte; all these constituents form a toxic and corrosive gaseous phase on the container, called “acid mist”; The environmental regulations require due protection for the health of the operators, according to Occupational Health and Hygiene legislation, as it is a polluted gaseous fluid highly harmful to human health, as well as highly corrosive to all equipment, structural and civil elements of the Plant industrial and stainless steel of cathode plates, and particularly of the welds between the electrode plates and their hanging bars of the electrical connection bars.

The acid mist health and hygiene problem apparently did not affect the industry until half a century after the U.S. Pat. No. 1,032,623 (probably due to the low current intensities operated at that time), but 54 years later, in 1976, MITSUI in GB 1,513,524, it proposes an insoluble anode covered with a fabric woven with parallel inert fiber and spaced from the anode, which extends over the electrolyte level to avoid the generation of acid mist to the environment, and to recover the generated effluent; the portion of the anode on the electrolyte is covered with an impermeable film on a mesh of the same material to form a sealed chamber that is provided with an outlet.

Similarly, in 1978, International Nickel Corporation INCO in U.S. Pat. No. 4,087,339, proposed separating each cathode from its adjacent anode with a pair of diaphragms; and in 1980, in U.S. Pat. No. 4,201,653, it also suggests bagging the anode.

In 1984, Smith in U.S. Pat. No. 4,584,082, proposed a method and apparatus for acid mist reduction based on a masking device to promote coalescence of acid mist bubbles. The masking device reduces the free surface of the electrolyte between the electrodes, which forces the bubbles to approach and their coalescence, and consequently, their increase in size, which results in a reduction in the volume of aerosols in the generated acid mist.

The same inventor, in 1987, proposed in U.S. Pat. No. 4,668,353, another improved coalescer device, attached to each anode.

In 1995, Minnesota Mining & Manufacturing, 3M, in patent application CL 1999-580, proposed to reduce the formation of acid mist by adding aliphatic fluoride surfactants that inhibit acid formation, with low foam formation.

Bechtel, in 1997, in U.S. Pat. No. 5,609,738, proposes a multi-element covering system installed below the electrical connections of the electrodes and on the surface of the electrolyte; is covered, it is evacuated in the interstices, in the confinement space, under it and over the electrolyte with a flow that exceeds the stoichiometric ratios that can cause the confined volume to escape, with the aim of avoiding the emission of acid mist on the cell.

CODELCO, in 1999, in patent application CL 1999-2684, proposed a procedure to inhibit the formation of acid mist in aerosols by adding an antifoam formulation composed of a glycol ester, an ethoxylate of alkyl phenol in a solvent paraffinic oil.

SAME, in 1999, in patent application CL 1999-247, proposed a high-energy hood for suction and capture of acid mist, connected to a centralized exhaust ventilation system, remote to the cells.

Also in 1999, Electro Copper Products in U.S. Pat. No. 5,855,749, proposed a system of transverse forced ventilation over the electrolyte.

Always in 1999, Hatch Africa in U.S. Pat. No. 6,120,658, proposed a method to capture, confinement and extraction of acid mist by a continuous enveloping anode cover, which is open at its lower end and closed at its upper end, adhered to the anode surface. The shell is formed of hydrophilic fibers that absorb liquid aerosols, returning them to the electrolyte, and simultaneously with porosity that allows the effluent gaseous fluid to escape.

TECMIN SA, in 2001, in patent application CL 2001-527, proposes an electrolytic cell for “zero emission of acid mist over the cell”, through capture, and forced extraction of acid mist to be remotely depurated, using thermal covers with irrigation of the electrical contacts, placed on the front walls higher than the side walls; said cell, which substantially decreases the acid mist in the operators working atmosphere, but does not depurated it to innocuous levels, works in conjunction with an electrolyte agitation system to simultaneously improve the transfer of ionic mass between the electrodes, in fact it is the precursor to the “triad” of the present invention.

CODELCO, in 2002, in patent application CL 1994-1965, proposes the inhibition or elimination of acid mist by adding to the electrolyte a soluble surfactant derived from the Quillaja Saponaria Molina tree.

NEW TECH COPPER, in 2004 and 2005, in patent applications CL 2004-2875 and CL 2005-570, proposes devices to control the acid mist produced, which includes insufflation of an air curtain on the free surface of the electrolyte with compressed air coming of distribution ducts and air injection nozzles located inside on both sides of the electrolytic container, inhibiting the release or formation of acid mist through heat exchange.

Ignacio Munoz Quintana, in 2005, in patent application CL 2005-2518, proposes plastic floating elements with elements adhered to the external surface of the float, which traps the polluting aerosols of the mist, preventing their release to the environment.

In 2006, BASF, in patent application CL 2006-328, proposed a process to reduce acid mist with at least one nonionic surfactant in the electrolytic solution.

COGNIS IP, in patent application CL 2007-2892, discloses alkoxylated compounds or sulfodetaines as anti-acid mist agents, with sulfate or sulfonate ends added in the electrolytic solution.

In 2007, TECNOCOMPOSITES SA, patent application CL 2007-2451, disclosed a system for the capture and removal of acid mist from the electrolytic cell, which has a plurality of flexible ceilings between anode and cathode, with a longitudinally concave shape in all its contact extension with removable lateral channels drilled above the electrolyte level and under the flexible ceilings.

In 2010 and 2011, NEW TECH COPPER, in patent applications CL 2010-1216 and CL 2011-1978, respectively proposed a system to confine the space on the electrolyte in a cell, and a mini-depurator device to reduce the leakage of sprays into the environment.

In 2013, Victor Vidaurre H., in U.S. Pat. No. 9,498,795 and INAPI CL 55,012-2017 (patent application CL 2013-1789) proposed a system for recovery and recycling of 99% of the acid mist generated in cells for electrowinning of copper, with discharge of the gaseous effluent with innocuous contents to the atmosphere.

### OBJECTIVES OF THE INVENTION

The simultaneity of the development and introduction to the market of solutions for both limiting problems of current art, stimulated the technical feasibility research to expand synergic possibilities between both solutions “cell by cell”, and led to the functional development of the joint operation as a triad for the holistic objective of this invention, which includes and takes advantage of a new thermal synergy that is incorporated into the concept of “electrochemical reactor”, specifically, an electrochemical reactor with the ability to simultaneously resolve the two limitations of the electrodeposition process in the electrowinning of copper.

From what has been said above, the present invention specifically refers to an innovative electrochemical reactor consisting of a container of the current art specially configured to house and operate in line a triad of synergic systems developed and implemented “cell by cell”, adjusting to the needs of existing plants with electrowinning processes for copper and other non-ferrous metals, conducted in specific plants. The triad consists of the following online devices:
AGSEL: Soft Electrolyte Agitation System with air diffusion,
CAR: Removable Anodic Covers System and,
SIRENA: Acid Mist Recycler System.

With all the above, the objectives of this invention are:

1.—To provide an electrochemical reactor, including: a container suitable for integrating one-method devices and a complex system of in-line functional means to produce favorable holistic effects that allow the stable conduction of copper electrodeposition process to be continuously sustained over time—and other non-ferrous metals—in a plurality of electrowinning reactors operating simultaneously at high current intensities.

2.—A Soft Electrolyte Agitation System (AGSEL) installed in the container to radically improve ionic mass capacity restrictions and air flow control of bubbling aeration directed to the intercathode spaces on the electrolyte, in determined flow rates, in ranges of continuous and pulsating pressure to provide soft air bubbling agitation directed into the intercathode spaces of the unit cells, in such a manner that it effectively usefully enhances the natural random bubbling of O₂ generated at the anodes of the cells of the current art in the cited Patents, and thereby making it technically feasible simultaneously to increase the productivity of the copper electrowinning process by continuously operating the electrolytic cells at high current intensities above 50% of current art standards (typically 280-300 A/m²); the containers can be the existing ones, suitably adapted to receive the “triad”, or new ones built to incorporate it. Increasing the current density at each cathode achieving ion mass transfer effectively applied compactly on their surfaces, as stated, simultaneously improves the physical and chemical quality of the copper electrodeposit, and therefore requires coupling online of a suitable system of substantial decrease of the acid mist resulting in the electrodeposition process, immediately installing in the container, said coupled system and in line with the agitation system, but with means for the substantial decrease of the global acid mist, that unlike patent application CL 2001-527, this invention proposes the means for global abatement with recovery of substances for recycling of acid mist, ensuring the environmental sustainability of the global electrodeposition process.

3.—A system for the substantial reduction of process acid mist at the same time that it is generated in electrochemical reactors, recovering it substantially suitable for immediate recycling to the process, which includes two in-line subsystems:
3.1 A System of Removable Anodic Covers (CAR) or “unit means” on each anode of the electrochemical reactor to contain, confine and substantially coalesce the acid mist, recycling a substantial portion of the coalesced acid mist back to the same reactor as it generates it.
3.2 An Acid Mist Recycler System (SIRENA) immediately online as a “global unit medium” (with respect to the “unit cells” of the electrochemical reactor) to complete the depuration of the gaseous fluid of acid mist effluent from the electrochemical reactor, reducing environmental pollution to innocuous levels, and at the same time, recycling the condensed aerosols and vapors to the electrodeposition process that originates them;

4.—Ensure that the process management has global sustainability, not only complying with environmental sustainability with the substantial reduction of the harmful acid mist, but also improving the operational problems of current art, by simultaneously minimizing both energy consumption (thermal and electrical), as well as losses of water vapor, electrolyte and acid sprays, to the ambient atmosphere when conducting the process.

5.—Substantially decrease the operational risks of the current art due to the action of harmful anions that attack the integrity of the electrodes in the areas highly exposed to the path of escape of the acid mist inside the electrochemical reactor, particularly in the welds of the electrodes with their hanging bars. This risk particularly affects the copper electrowinning industry in Chile, due to the presence of anions in the electrolytes from the leaching of oxidized minerals contained in the copper oxide deposits, especially in northern Chile.

### BRIEF DESCRIPTION OF THE DRAWINGS OF THE INVENTION

The accompanying drawings are included to provide a better understanding of the principles of functional concatenation to achieve the seven simultaneous in-line operations on the container operated at high current densities in this invention, illustrated, in a preferred embodiment for continuous operation. of the electrochemical reactor, with manual controls by trained operators; which is not restrictive, since it constitutes the simplest way, of several possible alternatives, for the continuous operation of the electrochemical reactor with more sophisticated semi-automatic and automatic control controls in versions that have already been validated; and that, moreover, they are not limiting for the development of electrochemical reactor improvements for which industrial protection is requested.

FIG. 1 shows a perspective view of the electrochemical reactor (1) for electrodeposition of copper and other non-ferrous metals that houses the “triad” AGSEL (100), CAR (200), and SIRENA (300) of the present invention for continuous operation sustained in time above the current limits of the electrodeposition process.

FIG. 2 shows a perspective view with vertical and cross section of the container (2) of the electrochemical reactor (1) to show the relative arrangement of the triad of AGSEL (100), CAR (200) and SIRENA (300) systems, which are functionally concatenated as shown, to achieve the objectives of the invention.

FIG. 3 shows a longitudinal section in elevation of the container (2) with the electrolyte (5) of the electrochemical reactor (1) in operation with the triad of concatenated systems of the electrochemical reactor (1). Controlled atmospheric air flow inputs (210), sustained over time, are shown in each interelectrode space through the multiple parallel flexible longitudinal seals (207) installed in each removable anode cover CAR (201), and thus ensuring, the impossibility of escape of acid mist into the atmosphere (3) over the electrochemical reactor (1), which is kept continuous with a minimum stable depression under the CAR System (200), by means of adequate individual suction in each unit cell of the container (2).

FIG. 4 shows a general perspective view of the AGSEL System (100) installed in the container (2) with the side walls of the electrochemical reactor (1) removed.

FIG. 4.1 shows a plan view of the self-supporting monolithic structural frame (101) of the AGSEL System (100), including its structural reticulated reinforcements (115), and the air supply system, to each rectangular module that supports removable air diffusers (102); A preferred embodiment is shown based on end-blind thermo-perforated flexible diffuser tubes (107). Optionally, the feeding system can be duplicated so as to feed the thermo-perforated flexible diffuser tubes (107) at both ends, increasing the overall capacity of diffusion of air bubbles (117) for agitation the electrolyte (5).

FIG. 4.2 shows a plan view of a typical rectangular air diffuser carrying module (102) with the thermo-perforated flexible diffuser tubes (107) installed in its air distributor manifold (108) and blind counter manifold (109) with the connection air supply at the supply connection point (105) from the self-supporting monolithic structural frame (101).

FIG. 5 shows in perspective an individual Removable Anodic Cover (201) of the CAR System (200), with the structural body of monolithic polymeric compound (206) of the removable anodic cover (201) provided with multiple parallel flexible longitudinal seals (207) arranged in their vertical sides, which serve to form at least two mini perimeter ventilated chambers (209) when the linear extremes of the multiple parallel flexible longitudinal seals (207) rest on the vertical flat faces of the cathode plates (11) that are inserted at their working positions in the electrochemical reactor (1) intercalated between the anode plates (10).

FIG. 5.1 shows a cross-sectional view of the electrochemical reactor (1) in elevation and the AGSEL (100) and CAR (200) Systems. The electrical power connections to the electrodes, the anode (10) and cathodic (11) plates are shown by means of the electric bus bar (8), which are installed on the electrode spacer insulating pieces (“capping boards”) (9). The “capping boards” (9) determine the length or pitch “center to center” between the anode (10) and cathodic (11) plates.

FIG. 5.2 in longitudinal section shows a detail of FIG. 3, of the connection of the container (2) with the SIRENA System (300), and serves to also illustrate the penetration of atmospheric air through the multiple parallel flexible longitudinal seals (207) of the CAR System (200).

The arrangement and material specifications of flexible seals are designed to allow controlled atmospheric air flow rates (210) to enter with the minimum suction necessary to prevent confined acid mist (3) from leaking into the atmosphere, and at the same time, said suction manages to “aerate” the mini perimeter ventilated chambers (209), sharing the volume with the acid mist inside. However, the atmospheric ventilation incoming air, due to its lower temperature compared to the acid mist temperature under the CAR System (200), initiates the coalescence of the electrolyte liquid droplets suspended as aerosols in the acid mist, at the same time, that the cold air flow rates of ventilation promote the increase of the already coalesced electrolyte droplets (5).

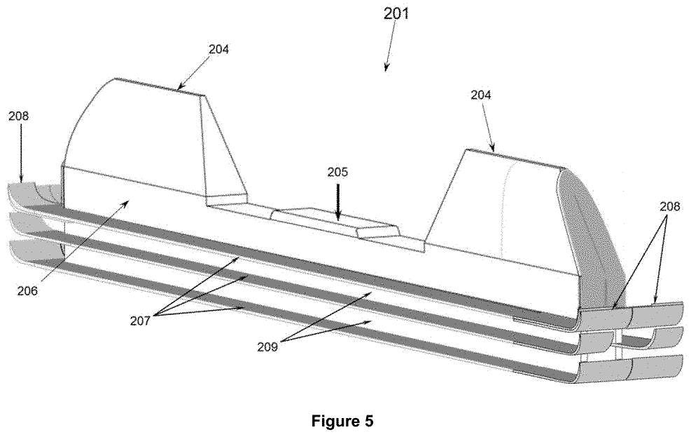

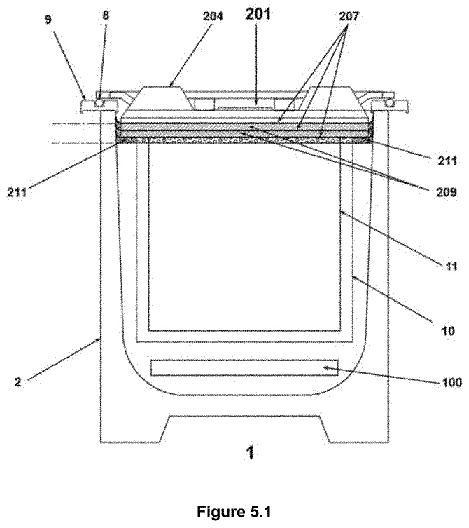

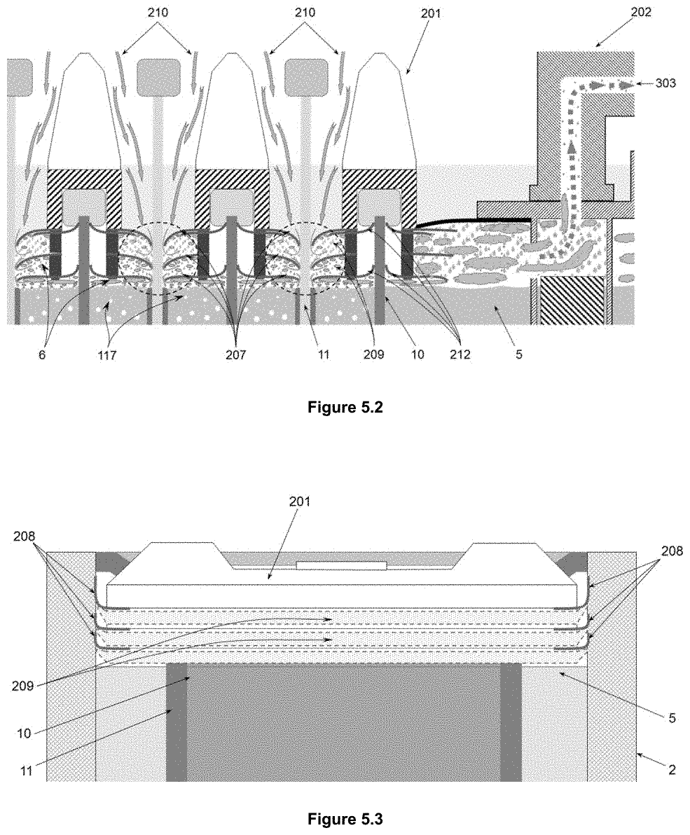

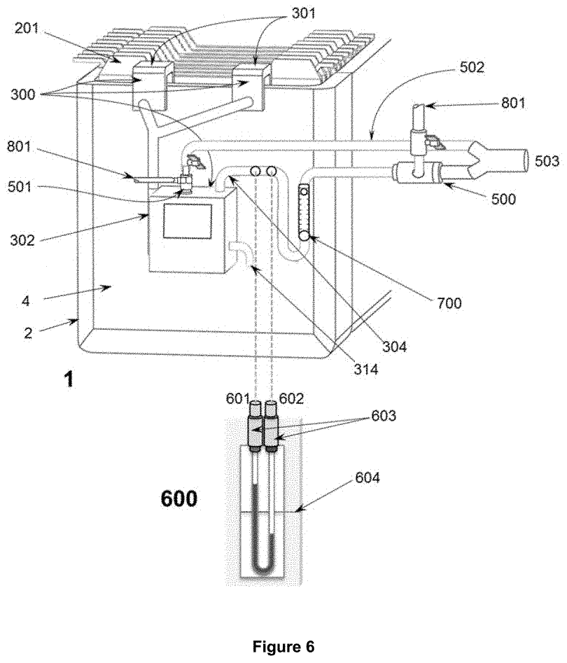

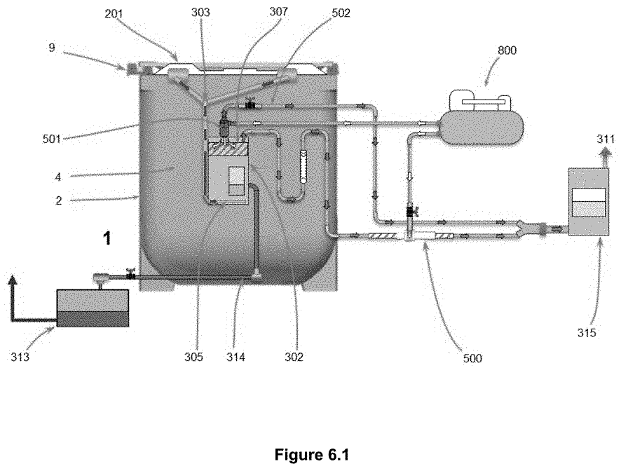

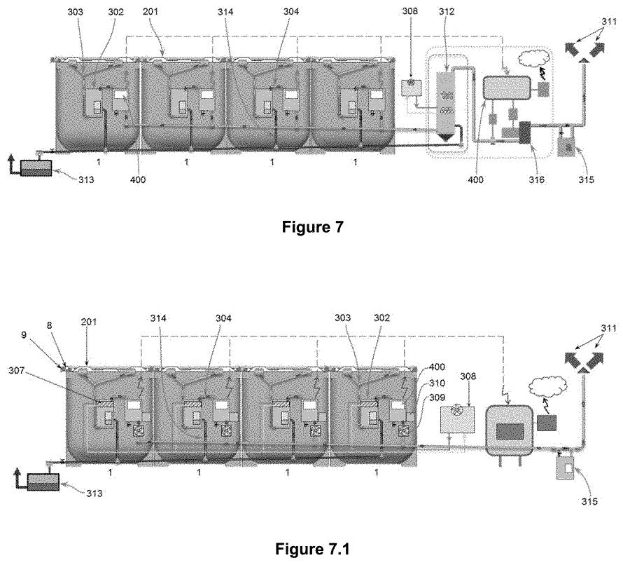

FIG. 5.3 shows the same cross-sectional view as explained in FIG. 5.2.

FIG. 6 shows a front perspective view of the container (2) with the CAR Systems (200) and the SIRENA System (300) in line, and its unified discharge of the global effluent gaseous fluid (503) from both systems to the AVDEVA (315) or global discharge into the atmosphere (311). Also shown is the portable removable device (600), verifier of the flow rate of the effluent gaseous fluid of each individual DEVA “V4” (302); and serves to confirm the accuracy of the flow readings delivered by the rotameters (700) over time.

FIG. 6.1 shows a front view of the electrochemical reactor (1) with the SIRENA System (300) installed on the outer front wall (4) of the container (2) with all the suction and condensation equipment to depurated the extracted gaseous fluid “cell by cell” (303) of the electrochemical reactor (1), by means of pneumatic devices without moving parts, which is the preferred embodiment of the present invention. In FIG. 6.1, the recovery of the acid condensate is included to substantially recover the condensates from the EW process of the electrochemical reactor (1) in the ACECOA Central Acid Condensate Accumulator (313) for immediate recycling of the condensates back to the process (314) in the electrochemical reactor (1); and also shows the discharge path of the harmless effluent gas flow (304), whose safety is verified (on average every 24 hours) by the AVDEVA Acid Vapor Verification Apparatus (315) before its global discharge into the atmosphere (311). This function of the AVDEVA is required to verify that the triad is properly concatenated and with correct settings to comply—very comfortably—the operation of the EW process within the permissible limits of contamination regulated for the location of each Plant.

FIG. 7 shows a front view of the installation diagram of an industrial prototype of the “cell by cell” execution, showing a plurality of 4 electrochemical copper reactors (1), in a configuration for an automatic continuous operation, which is supplied with centralized extraction device for the individual effluent gaseous fluids from the electrochemical reactors (1), by means of a variable speed extraction turbine (316) of the instantaneous global flow of effluent gaseous fluid extracted “cell by cell” (303), regulated in real time by a “Programmable Automation Controller” (CAP⁽⁴⁾) (400) that includes instantaneous monitoring and recording of process variables in real time and firmware for autonomous operation, which includes (optionally) secondary depuration by means of a DECOMUVA (312) device, a multi-stage condenser/depurator of acidic vapors—if required—to achieve extreme of innocuousness levels of the gaseous fluid effluent from the primary depuration in DEVA “V4” (302).

FIG. 7.1 shows a front view of the installation diagram of an industrial prototype of the “cell by cell” execution showing a plurality of 4 copper electrowinning electrochemical reactors (1), in a configuration for continuous semi-automatic operation with individual acid mist flow extraction from each electrochemical reactor (1) implemented by individual mini turbines (309) of variable speed, including an external cooling system (not shown) to the heat exchanger (307) in the DEVA “V4” (302) (which eliminates need for secondary depuration by ensuring innocuous contents, well below the DS 594 limit of personal exposure); and an instantaneous monitoring and recording system of process variables in real time, and firmware for autonomous operation installed in a prototype of the invention applied to 4 copper EW electrodeposition containers (2), including secondary depuration of the innocuous effluent gaseous fluid (304) from the primary depuration provided by DEVA “V4” (302).

### DESCRIPTION OF THE INVENTION

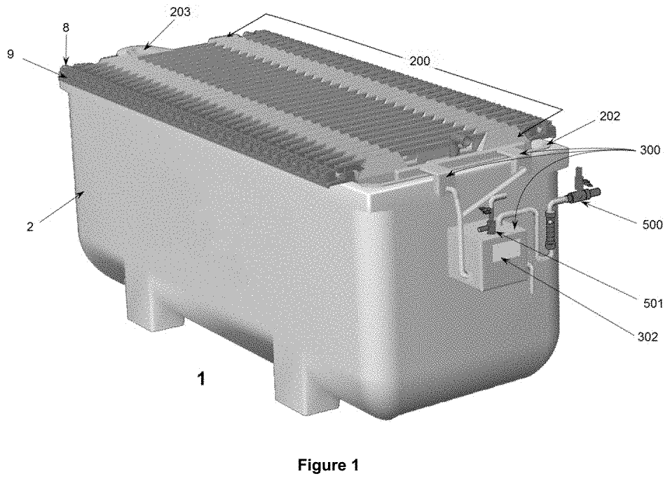

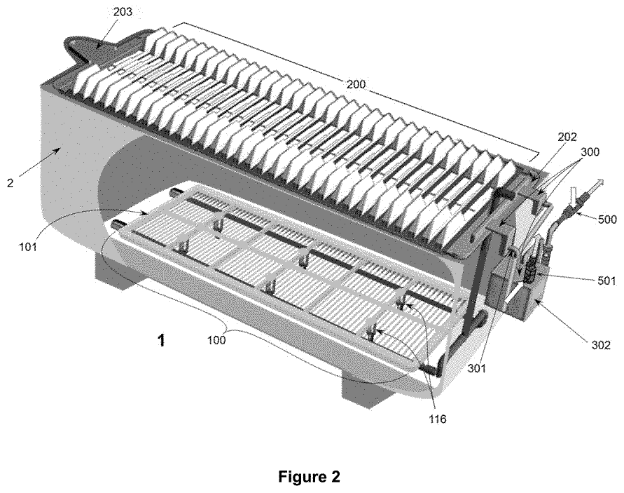

The objectives of the invention are implemented for a set of electrochemical deposition reactors (1) for copper—and other non-ferrous metals—operating with aqueous sulfuric solutions and anodic plates (10) of insoluble lead that generate O₂ bubbles (7), specifically configured to install and allow continuous operation of the triad of systems and equipment to accommodate specific “cell by cell” copper (and other non-ferrous metal) electrowinning processes conducted in various industrial plants currently operating at densities current of 250-320 A/m²; the installation and concatenation of the triad in the containers (2) enables them to operate sustainably with current intensities above 400 A/m²; the innovations presented serve as well for the design and construction of new electrowinning Plants for operation at high current densities from 350 A/m² and upwards, incorporating the same triad systems (FIGS. 1 and 2) of the invention, formed by:

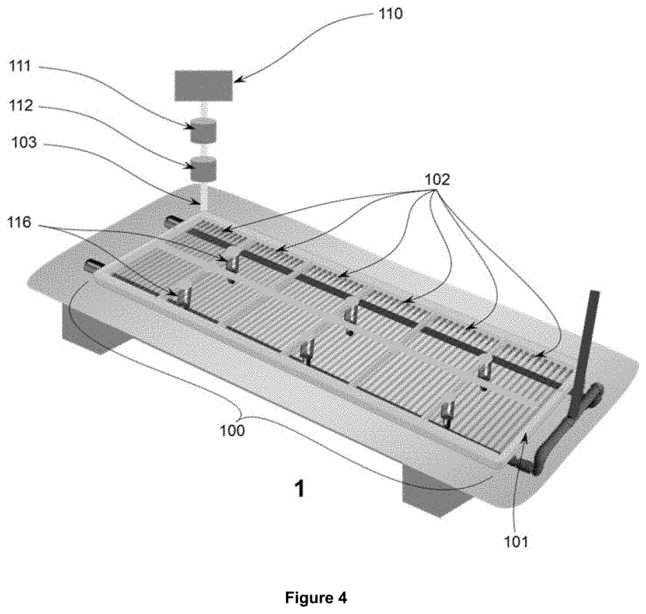

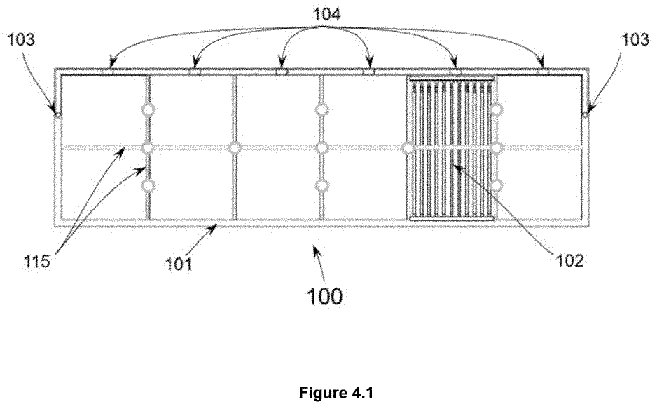

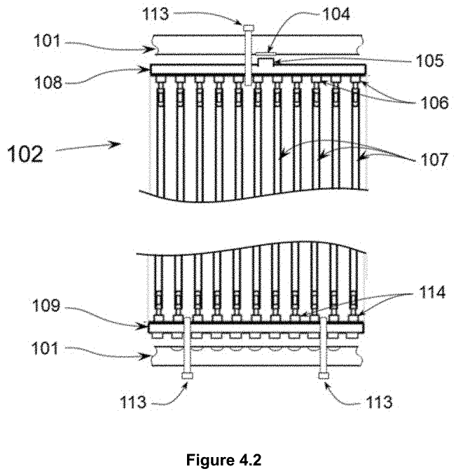

(4) “CAP”—abbreviation for “Programmable Automation Controller” in Spanish AGSEL System (100) Soft Agitation of Electrolyte serves to increase and improve homogeneity in the transfer of ionic mass from the electrolyte (5) to the cathodes (11) (FIGS. 2 and 4);

CAR System (200) serves to contain, confine, coalesce and recycle acid mist as it is generated in each electrochemical reactor (1) by means of Removable Anodic Covers (201) (FIGS. 1 and 2), and;

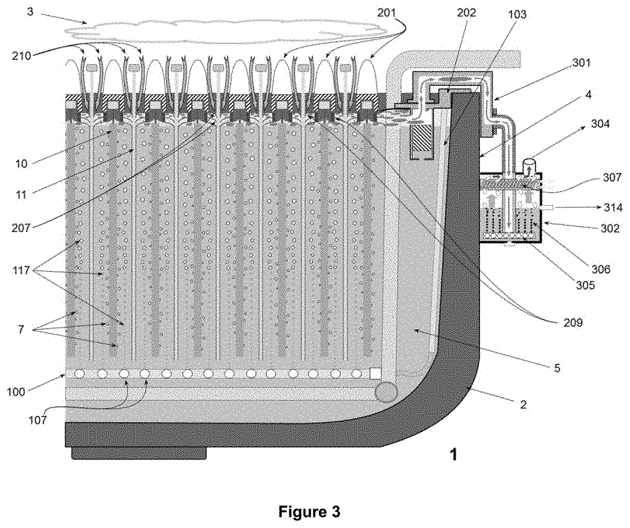

SIRENA Acid Mist Recycler System (300) serves to recycle aerosols and condense polluting vapors (FIGS. 3 and 6).

The continuous operation of the triad of systems, in the plurality of existing containers (2), in the tankhouse or electrowinning plant, can be operated and maintained concatenated, either manually or automatically, with the incorporation of a suitable Programmable Automation Controller (CAP) (400), which includes access to monitoring and instant registration of process variables.

The description below includes sufficient details to improve the understanding of the global concatenation of the triad of systems that make up the present invention and their sustained operation over time; therefore, they are incorporated and constitute part of the description with one of the preferred embodiments of the invention, which explain the application of the novel principles of the “cell by cell” solution and make viable its adoption on an industrial scale in existing industrial containers of the current art.

The Soft Electrolyte Agitation System (AGSEL) (100) installed in each container (2) of the electrochemical reactor (1), parallel and at a short distance from the bottom of the container (2), shown in FIGS. 2 and 4, is designed to homogeneously diffuse external atmospheric air in the electrolyte (5), feeding the air with control means for pulsating the aeration flow and pressure, so that the rows of small individual air bubbles (117) generated are of given diffused sizes, and above all, precisely directed so that they preferentially act in the intercathode spaces in each unit cell of the electrochemical reactor (1). The controlled directed O₂ bubble agitation of the AGSEL system (100), is discharged directly into the intercathode spaces, is intended to mix uniformly with the natural O₂ bubble agitation from the anodes, so as to generate together a soft upward turbulence parallel to the surfaces of the cathodic (11) and anodic (10) plates; the minimum air flow rates in individual bubble rows are designed from 0.65 liters per minute per linear meter of diffuser tube, which considerably increases the ion mass transfer with the emission of individual bubble rows that favor the homogeneity of the electrodeposit, even at densities above 400 A/m², and especially in the lower third portion of the cathode plates (11). Indeed, the decrease in minimum flow rate with controlled directed O₂ bubble agitation according to the present invention is of the order of ⅓ less than the minimum flow rates of the order of 1.9 liters per minute per linear meter achievable with a non-aeration configuration directed from current art. This consideration is significant because the transversely directed air bubbling system in the intercathode spaces as it is provided with rectangular modules carrying air diffusers (102) allows to increase the overall aeration flow to the container (2) of the order of 2.5 times With respect to the maximums of current gear, that is, the AGSEL System (100) can operate over 200 liters per minute, instead of being limited to about 80 liters per minute of current art systems; likewise, the air supply pressure of the AGSEL System (100) exceeds 200 mbar. Without these increases in controlled aeration capacities the results of industrial operation of the AGSEL System (100) could not accommodate the levels of current intensity increases disclosed in the present invention. All of the above also makes it possible to reduce the diameters of thermo-drilled holes below 0.8 mm in the current art, and/or also to use flexible pipes with smaller diameters and wall thicknesses.

The sustainability over time of the aeration ranges at the appropriate flow rates and pressures is maintained with a programmable solenoid valve that controls the flow of air supplied by pulses with a determined pressure and frequency that ensures that the holes of the diffuser flexible tubes are maintained free of obstructions.

In the AGSEL System (100) the minimum separation between adjacent rows of bubbles in the thermo-perforated flexible diffuser tubes (107) directed to each intercathode space can be reduced to 15 mm, a dimension that is 4 times less than the current art minimum of 70 mm.

The greatest generation of acid mist expected with the operation of the electrochemical reactor (1) at high current intensities is managed in coordination with the online installation of the pair made up of the CAR (200) and SIRENA (300) Systems, to configure with the AGSEL System (100) the triad of the present invention.

The Soft Electrolyte Agitation System (AGSEL) (100) is installed at a short distance on the bottom of the container (2) of the electrochemical reactor (1), in FIG. 4, radically increases the performance of electrolyte air agitation thanks to the transverse arrangement of the thermo-perforated flexible diffuser tubes (107); as mentioned, this allows duplicating the length of thermo-perforated flexible diffuser tubes (107) for any length of container (2). With what has been said, the AGSEL System (100) is capable of comfortably accompanying up-current intensities in the electrochemical reactor (1) proportional to the increase in intensity above 400 A/m², and predictably, up to 600 A/m².

The sustained operation of the electrochemical reactor (1) at high current intensity levels will test, sooner rather than later, the level of manual skill requirement of trained operators to keep the concatenation of the equipment consistently stable over time. Therefore, in order to project the indicated levels of raised current density, both the development and the validation of semi-automatic and automatic process control systems have already been advanced, and even the “firmware” required for eventual autonomous optimized operation of the complete electrowinning process if desired.

The air supply to the AGSEL System (100) requires pneumatic feeding devices to deliver a continuous flow range of 0 to 400 liters per minute at a pressure of 0 to 3 atmospheres, with means to generate pulses of controlled duration and spacing, including a rotameter and pressure switch (110); a pipe connects it (optionally) to pneumatic anti-siphon (111) and anti-return (112) devices, after connecting to the air inlet point (103) in the self-supporting monolithic structural frame (101), which is a PVC tube, typically at least 10 inches in diameter, externally reinforced by a continuous filament fiberglass and resin blanket. The air flow moves through the tube through the self-supporting monolithic structural frame (101), which supplies the air at the supply connection points (105) to each rectangular module that supports the air diffuser tubes (102), through the power connection point (105), which in turn feeds the manifold (108) of the rectangular module that supports air diffusers (102) and finally, to the thermo-perforated flexible diffuser tubes (107).

Each flexible diffuser tube with thermo-drilled holes (107) is attached to the manifold (108) with a feeder connector (106), from which air is diffused in rows of bubbles to the electrolyte (5); the ends of each flexible diffuser tube are blocked with a blind connector (114), where it is attached to the blind counter manifold (109); This, in turn, is fixed to the self-supporting monolithic structural frame (101) by means of bolts (113).

The distributor manifold (108) is molded of a monolithic polymeric compound and the blind counter manifold (109) houses the blind connectors (114) to remove the thermo-perforated flexible diffuser tubes (107). The manifold (108) is bolted to the self-supporting monolithic structural frame (101) through bolts (113) and likewise, the blind counter manifold (109) is fixed to the homologous member of the self-supporting monolithic structural frame (101) with bolts (113).

The number of rectangular air diffuser carrying modules (102) in the self-supporting monolithic structural frame (101) depends on the length of the container (2) of the electrochemical reactor (1), on the diameter of the thermo-perforated flexible diffuser tubes (107), and the separation distance between axles; and also of the hole-hole patterns in the surface of the thermo-perforated flexible diffuser tubes (107) and of the diameter of the holes and perforation patterns; all of which determines the air flow capacity required by the AGSEL System (100), which is calculated once the current intensity range at which the electrochemical reactor (1) is to be operated with its complete supply of electrodes is determined.

The AGSEL System (100) has height adjustable support supports (116) on the floor of the container (2), to be adjustable, as required, to maintain the horizontality of the self-supporting monolithic structural frame (101) with respect to the lower edges of the anode plates (10) and cathode plates (11) of the electrochemical reactor (1); and they can compensate for inclinations of the bottom or floor that the container (2) may have to facilitate its overflow.

Notwithstanding the foregoing, the AGSEL System (100) can also be supplied prepared to add thermo-perforated flexible diffuser tubes (107) in the total or partial perimeter of the self-supporting monolithic structural frame (101) in order to diffuse additional aeration to obtain effects hydrodynamic that may be necessary to support stable operation at high current intensities, to enhance additional diffusion favorable to the primary objective of directed external air bubbling in intercathode spaces.

A longitudinal section elevation of an electrochemical reactor (1) shown in FIG. 3, describes a plurality of removable anodic covers (201) that make up part of the CAR System (200) installed on each anode plate (10), together with the covers fixed (202) and (203) at each end of the container (2) of the electrochemical reactor (1) outside the area of anodic plates (10) and cathode plates (11), with which the CAR System (200) is completed for sealing the total surface of the electrolyte (5) with respect to the atmosphere (3) on the electrochemical reactor (1).

The CAR System (200), container, confiner, coalescer and also recycler of acid mist, in each electrochemical reactor (1), confines the aerosols of the acid mist (6) in the perimeter mini-ventilated chambers (209) where the micro drops of electrolyte in suspension forming drops of greater size and weight; as the micro drops gain weight, they first adhere to the available surfaces pushed by the ventilation generated by the entrance of atmospheric air to the container (2) through the plurality of multiple parallel flexible longitudinal seals (207) of the CAR system (200); As the droplets weight continues to grow, eventually they detach themselves cells from the surfaces to which they adhered, precipitating by gravity to the electrolyte (5) of the electrochemical reactor (1), in fact self-recycling.

After installing a removable anode cover (201) on each anode plate (10), with two vertical guide horns (204) provided, connected together by a horizontal seating plate (205) (for optional installation of wireless differential pressure sensor (605) (not shown) as required under the CAR System (200)); the vertical guide horns (204) are monolithic with the structural body (206) of dielectric polymeric mortar compound, highly corrosion resistant. The structural body (206) on both outer lateral sides, lodges multiple parallel flexible longitudinal seals (207) that protrude horizontally to contact the adjacent cathodic plates (11); while towards the inside of the lateral sides of the structural body there are two rows of flexible clamping tongues (212) to affix each anodic removable cover (201) onto each anodic plate (10). On the front ends, there are affixed two separate front seals (208) that cover the electrolyte (5) over the lateral channels (211) of the container (2). The multiple parallel flexible longitudinal seals (207) form at least two superimposed mini perimeter ventilated chambers (209), to: a.-) Promote the coalescence of the acid mist confined inside; coalescence is enhanced by ventilation with the entry of controlled flow rates of atmospheric air (210) that keep the mist confined under the multiple parallel flexible longitudinal seals (207). Coalescence takes place in the perimeter mini-ventilated chambers (209), since the controlled atmospheric air flow rates (210) are at a lower temperature than typical 50° C. of the electrolyte (5) in the copper electrowinning process, favoring the initiation of coalescence of the acid mist (6) with growth in size of the aerosols until reaching such a size that, due to their own weight, they fall back into the hot electrolyte (5) in the container (2) of the electrochemical reactor (1) that originated them. Recycling occurs simultaneously with the generation of acid mist in the operation of the electrochemical reactor (1), b.-) The multiple parallel flexible longitudinal seals (207) designed for the entry of atmospheric ventilation with the suction by the SIRENA system (300) in each mini ventilated perimeter chamber (209) of each removable anode cover (201) also serve to sweep cathodic and anode surfaces and keep them clear of vapors and aerosols, thereby providing anti-corrosive protection for body/hanger bar welds cathodic (11) and anodic (10) plates due to the possible presence of anions, (which are generally present in the electrolyte (5) and come from the ore leaching stage, as entrained contaminants). Removable Anodic Covers (201) substantially prevent the formation of copper sulfate in the socket contacts of the electric bars/electrode hanger bars, thus avoiding process current leaks.

To implement anion protection with the multiple parallel flexible longitudinal seals (207) of the CAR System (200) it is necessary to establish the average level of the electrolyte (5) in the industrial container (2) of the current art—or in the electrochemical reactor (1)—of a given Plant or tankhouse, to fix the distance of the multiple parallel flexible longitudinal seal (207) with respect to the position of the structural body of monolithic polymeric compound (206) of the removable anode cover (201) already seated on the anodic plate (10) such that the line of contact of the multiple parallel flexible longitudinal seal (207) of the mini perimeter ventilated chamber (209) closest to the level of the electrolyte (5) with the cathodic plate (11) is just above said level, so that the volume of gaseous fluid confined by the CAR System (200) in the electrochemical reactor (1) is entrained and extracted from it together with the acid mist.

With reference to the drawings, FIG. 3 and FIG. 6 show sectional views of the SIRENA System (300) including the collection manifold (301) of the effluent gaseous fluid extracted “cell by cell” (303) from the reactor container (2) electrochemical (1) to deliver it to the DEVA “V4” gaseous effluent vapors depurator (302) attached to one of the ends of the electrochemical reactor (1) with its ducts for feeding the extracted gaseous fluid flow “cell by cell” (303) of each electrochemical reactor (1).

The SIRENA System (300), linked in line with the CAR System (200), recovers and substantially reduces acidic vapors, recycling the acid mist aerosols (6) remaining in the flow of the gaseous effluent fluid extracted “cell by cell” (303) of the electrochemical reactor (1), to be immediately depurated, outside the container (2) of the electrochemical reactor (1), in the first instance, by means of a gaseous fluid bubbler (305) that operates under a liquid column (306) of adjustable height in the DEVA “V4” acid effluent vapor depurator (302) installed on the outer front wall (4) of each container (2). Each bubbler (305) of the DEVA “V4” (302) recovers substantially, of the order of 95˜98% of the uncoalesced micro aerosols in the container (2) and which are dragged to the DEVA “V4” (302) and recovered in the form of liquid condensate; at the same time, on the liquid column (306) of the bubbler (305), always inside the DEVA “V4” (302), with the bubble, bubble explosions take place when emerging from the level of liquid condensate. To minimize water vapor and new aerosols generated in DEVA “V4” (302), forced condensation is introduced by means of a heat exchanger (307), to substantially recover the new aerosols and vapors in the effluent gaseous fluid extracted from the DEVA “V4” (302). The suction of the extraction flow of the extracted effluent gaseous fluid “cell by cell” (303), is provided, in the preferred embodiment, by means of a pneumatic air amplifying device (500), which operates with dry and compressed atmospheric air (801), preferably provided by a screw compressor (800), or alternatively, with a mini turbine (309) provided with its frequency variator (310) to control the extraction flow, installed in each container (2) of the electrochemical reactor (1).

The continuous operation over time of a plurality of electrochemical reactors (1) requires setting the overall flow rate of extraction of individual effluent gaseous fluid from each electrochemical reactor (1), in such a way that said suction maintains a depression over time of at least 2 mbar under the removable anode covers (201) of the CAR System (200) of each container (2) of the electrochemical reactor (1). This condition is essential to guarantee zero emission of acid mist from the electrochemical reactor (1) to the working environment.

The triad of the present invention—as stated—can be operated and maintain the indicated essential condition manually, automatically or autonomously.

In case of using a Programmable Automation Controller (CAP) (400); with or without autonomic capacity, the mini extraction turbines (309) or preferably, the air amplifiers (500) and Vortex tubes (501), in each electrochemical reactor (1), are in charge of moving the extracted effluent gaseous fluids “cell by cell” (303) of each electrochemical reactor (1) discharging them directly to their DEVA “V4” acid effluent steam depurator (302), which when cooled prior to their global discharge into the atmosphere (311), by heat exchanger (307) with atmospheric air cooled preferably by pneumatic device Vortex Tube (501), or alternatively by a Chiller (308) that cools conventional refrigerant fluid, such as Glycol, cooled in a range of 1 to 4° C.

The SIRENA System (300) is designed to safely discharge the global gaseous effluent from each electrochemical reactor (1) directly into the atmosphere. Alternatively, or as required, the SIRENA (300) is also designed to be able to incorporate online, prior to discharge to the atmosphere, a second DECOMUVA multi-stage depurator/condenser (312) and to couple a pneumatic air supply system atmospheric pressure of the triad to maximize the safety of the effluent gaseous fluid.

1. Electrochemical reactor (1) for the conduction of electrodeposition processes of non-ferrous metals that operates with a container (2) of tried-and-tested monolithic polymer concrete, where a flow of a suitable electrolyte solution of given characteristics fed by a tuning fork to the surfaces of the cathode plates (11) energized in the interelectrode spaces of the electrochemical reactor (1) provide sufficient ion mass transfer for the proper integrity and uniform compaction of the metal deposits when operating stably—at the corresponding intensities current—the process of electrowinning metals to their so-called “limit current density”; at higher current densities, the balances between the process variables become unstable and lose the balances with which acceptable deposit results are achieved, and objectionable physical quality defects and impairments begin to be generalized in the metallic sheets, as well as degradation in their chemical composition due to the presence of impurities in the electrolyte that are electrodeposited together with the metal; on the other hand, in the process operation—at any current intensity—the solution decomposes, generating micro O₂ bubbles (7) on the anode surfaces; the bubbles grow ascending through the electrolyte incorporating its gases, and when emerging into the atmosphere (3) they explode, configuring the problematic acid mist, gaseous fluid composed of gases in the electrolyte, water vapor, sulfuric acid and sulfurous electrolyte aerosols, highly harmful to health, CHARACTERIZED because it comprises a triad of concatenated sets of devices for continuous online operation in the electrochemical reactor (1), which allows the process to be operated at high current densities with simultaneous control and mitigation of the acid mist effluent; this triad is made up of:
a) AGSEL (100) set of bubble flow controlled flow rate air diffusers, with or without pulses, to improve ion mass transfer as appropriate for current density operated in the electrochemical reactor (1), which is capable of accommodating current intensities up to 600 A/m²; The AGSEL (100) is made up of a self-supporting monolithic structural frame (101) that contains rectangular modules that carry air diffusers (102) to diffuse air in the form of bubbles (117), which are fixed with bolts (113) designed for quick replacement of the rectangular air diffuser carrying modules (102);
b) Set of CAR (200) devices for containment, confinement, coalescence and recycling of electrolyte aerosols entrained in the acid mist generated by the process; the CAR assembly is made up of a series of individual removable anodic covers (201) on each anode of the electrochemical reactor (1); each cover consists of a structural body (206), monolithic molded of polymeric compound, with dielectric properties, high structural and corrosion resistance to be installed superimposed on each anodic plate hanging bar (10) under pressure; and two fixed covers (202) and (203) at the ends of the container (2); the individual removable anode covers (201) are held in each anode plate (10) by flexible holding tabs (212) inside the structural body of monolithic polymeric compound (206); on its upper part, it also has two vertical guide horns (204) joined by a horizontal settlement plate (205), which also serves to eventually install wireless differential pressure sensors under the individual removable anode covers (201) with regarding the atmosphere; the structural body on its lateral sides also accommodates at least two multiple parallel flexible longitudinal seals (207) superimposed on both sides and;
c) SIRENA Apparatus Set (300) which is attached to an outer front wall (4) of each container (2) of the electrochemical reactor (1) to suck the flow of the effluent gaseous fluid and extract it from the container (2) to discharge it in the DEVA device (302)—acid vapor depurator—whose functions are to separate and recover as acid condensate: water vapor, sulfuric acid and electrolyte aerosols entered as acid mist from the electrochemical reactor (1); the depuration is of controlled intensity and allows increasing the safety of the effluent gaseous fluid, and directing the effluent gas flow from DEVA (302) to the global discharge to the external atmosphere (311), or to secondary depuration in at least one device DECOMUVA multi-stage acid vapor condenser depurator (312), if the requirement of safety in atmospheric discharge requires it.

2. Electrochemical reactor (1) according to claim 1, CHARACTERIZED in that the thermo-perforated flexible diffuser tubes (107) air diffusers in their rectangular bearing modules (102), are arranged parallel to the electrodes under the interelectrode spaces, and the number of Rectangular bearing modules for air diffusers (102) depend on the length of the electrochemical reactor (1), size, number of flexible thermo-perforated diffuser tubes (107) to diffuse the agitation air and the overall flow rate of aeration required in the interelectrode spaces to the inside the container (2) according to the range of current intensity operated in the electrochemical reactor (1).

3. Electrochemical reactor (1) according to claim 1, CHARACTERIZED because it also comprises a flow of atmospheric diffusion air that feeds the self-supporting monolithic structural frame (101), first passing through a rotameter and pressure switch (110), and then, optionally, by an anti-siphon device (111) in line with an anti-return device (112), prior to entering through the air entry point (103) into the self-supporting monolithic structural frame (101); by means of a PVC tube of at least 10 inches in diameter, externally reinforced by a continuous filament blanket (fiberglass and resin) encapsulated in the monolithic structural polymer mortar of the self-supporting monolithic structural frame (101), the diffusion air flow It moves through the self-supporting monolithic structural frame (101), which internally has T joints at the T connection points (104), to supply air to each rectangular module that supports air diffusers (102), through the connection point of power (105).

4. Electrochemical reactor (1) according to claim 3, CHARACTERIZED in that the rectangular modules that support the air diffusers (102), comprise a manifold (108), which is attached to the self-supporting monolithic structural frame (101) through the point The power connection (105) and the blind counter manifold (109) are bolted to the self-supporting monolithic structural frame (101) and accommodates the blind connectors (114) to insert the thermo-perforated flexible diffuser tubes (107).

5. Electrochemical reactor (1) according to claim 4, CHARACTERIZED in that the manifold (108) has feeder connectors (106) to insert the thermo-perforated flexible diffuser tubes (107).

6. Electrochemical reactor (1) according to claim 5, CHARACTERIZED in that the thermo-perforated flexible diffuser tubes (107) with perforations arranged in their length from which emerges the controlled diffuser air flow to each thermo-perforated flexible diffuser tube (107) so that vertically ascending rows of individual air bubbles (117) are formed in the electrolyte (5), and in diffusion patterns determined by design.

7. Electrochemical reactor (1) according to claim 1, CHARACTERIZED because the characteristic of the air bubble (117), depends on the air flow and pressure, drilling diameter and number of holes per linear meter of flexible diffuser tubes thermo-drilled (107) to deliver the flow rate required for each flexible thermo-drilled diffuser tube (107) in determined bubble diffusion patterns to enhance the desired bubbling uniformity in each interelectrode gap.

8. Electrochemical reactor (1) according to claim 1, CHARACTERIZED because in the self-supporting monolithic structural framework (101) it is provided with height adjustable support supports (116) from the bottom of the container (2), to maintain the horizontality of the self-supporting monolithic structural frame (101) with respect to the anode plates (10) and cathodic plates (11) suspended vertically from the upper edges of the side walls of the container (2) of the electrochemical reactor (1).

9. Electrochemical reactor (1) according to claim 1, CHARACTERIZED in that the front ends of the structural body of monolithic polymeric compound (206), in which the multiple parallel flexible longitudinal seals (207) are housed, superimposed and at least double front seals (208) that cover the electrolyte (5) in the lateral channels (211) resting on the adjacent side walls of the container (2) of the electrochemical reactor (1).

10. Electrochemical reactor (1) according to claim 9, CHARACTERIZED in that the multiple superimposed parallel flexible longitudinal seals (207) form at least two superimposed ventilated perimeter mini-chambers (209), to initiate, enhance and promote the coalescence of the electrolyte aerosols in the acid mist confined inside the superimposed perimeter mini ventilated chambers (209) with the continuous entry of controlled atmospheric air flow rates (210) at a lower temperature than the ambient temperature inside the superimposed perimeter mini ventilated chambers (209).

11. Electrochemical reactor (1) according to claim 10, CHARACTERIZED in that it comprises multiple superimposed parallel flexible longitudinal seals (207) that rest against the vertical flat surface of the cathode plate (11), in the mist confinement volume acid that ends in the lines of support of the multiple superimposed parallel flexible longitudinal seal (207) with the cathodic plate (11).

12. Electrochemical reactor (1) according to claim 1, CHARACTERIZED because CAR (200) and SIRENA (300) are designed to operate concatenated in order to recover the water vapor, sulfuric acid and the electrolyte aerosols remaining in the flow rate of the effluent gaseous fluid extracted “cell by cell” (303) out of the electrochemical reactor (1).

13. Electrochemical reactor (1) according to claim 12, CHARACTERIZED in that the acidic vapors and aerosols extracted from the electrochemical reactor (1) in the effluent gaseous fluid, in the first instance, are captured in the DEVA acidic vapor depurator apparatus (302) by a bubbler (305) under a height adjustable liquid column (306) installed on an outer front wall (4) of each container (2).

14. Electrochemical reactor (1) according to claim 13, CHARACTERIZED in that, optionally, it can also comprise an apparatus for checking the contents of contaminating acidic vapors AVDEVA (315) remaining in the gaseous fluid effluent from the DEVA acidic vapor depuration apparatus (302) prior to its global discharge into the atmosphere (311) environment.

15. Electrochemical reactor (1) according to claim 14, CHARACTERIZED in that the suction to generate the extraction flow of the extracted fluid gas flow “cell by cell” (303), is provided in a preferred embodiment with amplifying apparatus of air (500) without moving parts powered by a compressed atmospheric air network (801) externally supplied by a continuous flow compressor (800) (screw or other), or alternatively, in each electrochemical reactor (1) by means of a mini turbine (309) with a very low flow rate, powered by an electric motor, preferably with a frequency variator (310).

16. Electrochemical reactor (1) according to claim 12, CHARACTERIZED because it also has an input that communicates to a differential flow pressure sensor apparatus on a calibrated orifice plate (601), an orifice plate sensor output (602), a calibrated orifice plate (603), a rotameter (700), whose compressed atmospheric air (801) is provided by a screw compressor (800).

17. AGSEL Soft Electrolyte Agitation System (100), which when working generates individual rows of controlled air bubbles (117), where the flow of a suitable solution of electrolyte of given characteristics fed by a tuning fork to the surfaces of the cathode plates (11) energized in the interelectrode spaces of the electrochemical reactor (1) provide sufficient ion mass transfer for the proper integrity and uniform compaction of the metal deposits by operating stably—at the corresponding current intensities—the process of electrodeposition of metals only up to their so-called limit current density; at higher current densities, the balances between the process variables become unstable and begin to lose the balances with which acceptable deposit results are achieved, and objectionable physical quality defects and impairments begin to occur in the metal sheets, as well as degradation in its chemical composition due to the presence of impurities in the electrolyte that are electrodeposited together with the metal; CHARACTERIZED because a horizontal self-supporting monolithic structural frame (101) is located in each electrochemical reactor (1) near the bottom of the container (2), designed to homogeneously diffuse outside air, in a controlled way that suitably directs the rows of emerging bubbles in the interelectrode spaces, in the form of small individual air bubbles (117), with which it is possible to considerably increase the transfer of ionic mass from the boundary layer of the cathode plates (11), which allows to effectively accompany current intensities up to 600 A/m².

18. AGSEL soft electrolyte agitation system (100) according to claim 17, CHARACTERIZED in that the thermo-perforated flexible diffuser tubes (107) air diffusers in their rectangular bearing modules (102), are arranged parallel to the electrodes under the interelectrode spaces, and the number of modules (102) depends on the length of the electrochemical reactor (1), size, number of flexible thermo-perforated diffuser tubes (107) to diffuse the agitation air and the overall flow rate of aeration required in the spaces interelectrodes inside the container (2) according to the range of current intensity operated in the electrochemical reactor (1).

19. AGSEL soft electrolyte agitation system (100) according to claim 18, CHARACTERIZED in that the thermo-perforated flexible diffuser tubes (107) have perforations arranged in rows along which air bubbles emerge (117) individual forming rows with discharge directed towards the electrolyte (5) in the interelectrode spaces.

20. AGSEL soft electrolyte agitation system (100) according to claim 19, CHARACTERIZED because the characteristics, sizes, intervals of individual air bubbles (117) desired between each other when emerging into the electrolyte (5), depend on the flow rate of continuous air and of the pulses of the flow, of the diameter of the perforations, of their perforation pattern and the quantity of flexible thermo-perforated diffuser tubes (107) necessary to diffuse air in each interelectrode space per rectangular module carrying air diffusers (102).

21. System of removable anode covers CAR (200), to contain, confine, coalesce and recycle acid mist, highly harmful to health, in each unit cell of the electrochemical reactor (1), because the volumes of oxygen (02) generated in the current industrial electrowinning processes of copper and other non-ferrous metals are directly proportional to the current intensities applied to the anodes, and therefore, to the environmental contamination associated with the operation of the electrowinning cells of the current art, CHARACTERIZED because the removable anode covers (201) are individual, of “remove and put” for each anode plate (10), they are easily removable from their seat on their anode hanger bar, and can be firmly installed by the simple pressure resulting from inserting on the horizontal part of the structural body of monolithic polymeric compound (206) of the individual removable anodic cover (201) on the hangers It is horizontal of the anode plates (10), since they have ad hoc clamping means with flexible clamping tabs (212) to be firmly locked in the working position by mere insertion pressure, and therefore, at the same time they are easily removable by a trained operator; The CAR System (200) also includes fixed covers (202) and (203) at the ends of the container (2) of the electrochemical reactor (1) and are installed over the free spaces of anodic plates (10) and cathode plates (11) at each end of the container (2).

22. System of removable anode covers CAR (200) according to claim 21, CHARACTERIZED because it also includes the means for the entrance of controlled flows of atmospheric air (210) in each interelectrode space through the support line against the cathode plate (11) adjacent to the multiple overlapping parallel longitudinal flexible seals (207) installed in each individual removable anode cover (201) to admit a controlled entry in a range of minimum external air flow rates necessary to produce a slight vacuum under the covers individual removable anodes (201) and thus ensure the impossibility of escape of acid mist in the opposite direction to the flow of air entering from the atmosphere (3), over the electrochemical reactor (1), maintaining the minimum necessary depression continuously over time the CAR System (200).

23. System of removable anode covers CAR (200) according to claim 21, CHARACTERIZED because it also comprises at least two superimposed ventilated perimeter mini-chambers (209), to contain, confine and coalesce the liquid aerosols of the acid mist with the suction of an external air flow, whose temperature lower than that of the superimposed perimeter mini-ventilated chamber (209) initiates and promotes coalescence, increasing the size of the micro drops in suspension to larger and heavier drops that they adhere, first to the available surfaces, and then with the subsequent increase in volume and weight, they detach from the same surfaces when their individual weight exceeds their adhesion with the surfaces to which they were adhered, precipitating by gravity to the electrolyte (5) of the reactor electrochemical (1), which generates them in real time.

24. CAR removable anodic roof system (200) according to claim 22, CHARACTERIZED in that the multiple superimposed parallel flexible longitudinal seals (207) and the path of egress of the coldest external atmospheric air of the superimposed perimeter mini ventilated chambers (209) provide protection from corrosive anions to the stainless steel material of the cathode plates (11), since the lower seal of the lower superimposed perimeter mini-chamber (209) closest to the electrolyte level is just above the electrolyte level (5), whereby the emission of external atmospheric air by the seal of the superimposed perimeter mini-ventilated chamber (209) constantly sweeps the cathodic surfaces, protecting them from the onset of corrosion.

25. Removable anodic cover system CAR (200) according to claim 23, CHARACTERIZED because the confinement of the liquid aerosols of the acid mist (6) is inside the superimposed perimeter mini-ventilated chambers (209) formed by the minus two multiple perimeter overlapping parallel flexible longitudinal seals (207) abutting against the vertical flat surfaces of the adjacent cathode plates (11); the multiple overlapping parallel flexible longitudinal seals (207) are preferably housed in longitudinal grooves in the monolithic polymer composite structural body (206) of the individual removable anode covers (201) in each anode plate (10), and further have two horns vertical guides (204) to facilitate smooth re-entry of the empty cathode plates (11) after harvests to their working position in the inter-anode spaces; on the upper horizontal face of the monolithic polymer composite structural body (206); On its upper part, it also has two vertical guide horns (204) joined by a horizontal settlement plate (205), which also serves to eventually install wireless differential pressure sensors under the individual removable anode covers (201), to ensure the control of depression under the CAR System (200) with respect to the atmosphere; which ultimately ensures the impossibility of the acid mist escaping into the atmosphere (3) over the electrochemical reactor (1).

26. System of removable anode covers CAR (200) according to claim 21, CHARACTERIZED because it also comprises a container (2), based on a dielectric polymeric compound, with high structural resistance, and chemical resistance to corrosion, and strategically designed to locate the housings of the multiple overlapping parallel flexible longitudinal seals (207) on both sides, and at least double front seals (208) covering the electrolyte (5) in the side channels (211) adjacent to the side walls of the container (2) of the electrochemical reactor (1).

27. CAR removable anodic cover system (200) according to claim 21, CHARACTERIZED in that the multiple superimposed parallel flexible longitudinal seals (207) that form at least two superimposed perimeter mini ventilated chambers (209), to promote the coalescence of the acid mist confined within it;

28. Effluent gaseous fluid depurator system extracted “cell by cell” (303) from the electrochemical reactor (1) SIRENA (300), to reduce the remaining water vapor, sulfuric acid and electrolyte aerosols remaining, highly harmful to the health, that may have been entrained in the effluent gas flow from the container (2) of the electrochemical reactor (1), because the volumes of oxygen (02) generated in the current processes of industrial electrowinning of copper and other non-ferrous metals are directly proportional to the current intensities applied to the anodes, and consequently, to the environmental contamination associated with the operation of the electroobtaining cells of the current art, CHARACTERIZED because it comprises a collection manifold (301) of at least one discharge of the fluid effluent gas extracted “cell by cell” (303) from the container (2) of the electrochemical reactor (1) and discharging it through the lower part of the access to the bubbler (305) installed on the interior floor of the DEVA acid vapor depurator (302) attached to an exterior front wall (4) of the container (2) in the electrochemical reactor (1); Two effluent gaseous fluids are discharged from the DEVA acid vapor depurator apparatus (302): (a) liquid fluid condensed with water vapor and acid that is led to a central accumulator of acidic condensates ACECOA (313); and (b) substantially harmless effluent gaseous fluid (304) treated by the DEVA acid vapor depurator apparatus (302) that is discharged directly into the atmosphere (311), or to secondary depurators in at least one multi-stage condenser depurator apparatus. DECOMUVA (312) acidic vapors, if the requirement of safety in atmospheric discharge requires it.

29. SIRENA (300) water vapor, acid and electrolyte aerosol recycling system, according to claim 28, CHARACTERIZED because in its first instance the gaseous fluid enters through a bubbler (305) under a liquid column (306) height adjustable in the DEVA acid vapor depurator (302) installed on the outer front wall (4) of each container (2) of the electrochemical reactor (1).

30. Recycling system for water vapor, acid and electrolyte aerosols SIRENA (300), according to claim 28, CHARACTERIZED in that the suction to generate flow rates of the gaseous fluid effluent extracted “cell by cell” (303), At sustained levels of the “Null Escape” condition, it is preferably provided by means of an air amplifier (500) without moving parts, or else a mini turbine (309) with its frequency variator (310) in each electrochemical reactor (1).

31. Recycling system for water vapor, acid and electrolyte aerosols SIRENA (300), according to claim 28, CHARACTERIZED because also the process control of the effluent gas depurator system “cell by cell” extracted (303) from the electrochemical reactor (1) to the SIRENA System (300) is not limited only to manual control.

32. Electrochemical method for the conduction of electrodeposition of non-ferrous metals that operates with a container (2) of tried-and-tested monolithic polymer concrete, where a flow of a suitable electrolyte solution of given characteristics is fed by a tuning fork to the surfaces of the cathode plates (11) energized in the interelectrode spaces of the electrochemical reactor (1) provide sufficient ion mass transfer for the proper integrity and uniform compaction of the metal deposits by operating stably—at the corresponding current intensities—the process electrowinning of metals up to its so-called “limit current density”; at higher current densities, the balances between the process variables become unstable and lose the balances with which acceptable deposit results are achieved, and objectionable physical quality defects and impairments begin to be generalized in the metallic sheets, as well as degradation in their chemical composition due to the presence of impurities in the electrolyte that are electrodeposited together with the metal; on the other hand, in the process operation—at any current intensity—the solution decomposes, generating micro O₂ bubbles (7) on the anode surfaces; the bubbles grow ascending through the electrolyte incorporating its gases, and when emerging into the atmosphere (3) they explode, configuring the problematic acid mist, gaseous fluid composed of gases in the electrolyte, water vapor, sulfuric acid and sulfurous electrolyte aerosols, highly harmful to health, CHARACTERIZED because it comprises: a) Locating a horizontal self-supporting monolithic structural frame (101), of the AGSEL Set (100) in each electrochemical reactor (1) near the bottom of the container (2), which has been designed to homogeneously diffuse outside air, in the form of small individual air bubbles (117), in a controlled manner, directing the rows of emerging bubbles in the interelectrode spaces, enhancing the transfer of ionic mass from the electrolyte (5) to the cathode plates (11) to operate at high current intensities above 400 A/m², and predictably, up to 600 A/m²; once the air bubbles emerge from the electrolyte surface, they explode and join the acid mist that occupies the volume under the removable anode covers (201) of the CAR Apparatus Set (200) and the acid mist rises entering the mini chambers of the removable anodic roofs (201), where it is knocked down by coalescence, which is promoted by the entry of controlled atmospheric air flow rates (210) substantially at a lower temperature than that of the environment inside the superimposed perimeter mini-chambers (209) in each of the unit cells and,
b) Air enters the acid mist confinement volume in each unit cell of the container (2); and then, this same air, already in the confining volume on the electrolyte in each unit cell, drags the confined acid mist transversely towards the lateral channels (211) of the container (2); and then, when leaving the lateral channels (211), the gaseous flow of each unit cell moves through the lateral channels (211) towards the front suction wall of the container (2);
c) The effluent gas flow from the electrochemical reactor (1) enters through the collection manifold (301) into the SIRENA assembly (300) in each container (2) of the electrochemical reactor (1), the entrance of atmospheric air at the height of the volume confinement of the acid mist in each unit cell is a short distance from the surface of the electrolyte (5), which prevents the permanence of corrosive emerging gaseous anions of the electrolyte in the strip of the protruding surface of the cathode plate (11) on the electrolyte (5) over the entire width of the cathode plate (11) in the unit cell, reducing the possibility of eventual corrosion of the cathode plates (11) precisely in the critical area on the electrolyte of the electrochemical reactor (1).

33. Electrochemical method according to claim 32, CHARACTERIZED in that the thermo-perforated flexible diffuser tubes (107) air diffusers in their rectangular bearing modules (102), are arranged parallel to the electrodes under the interelectrode spaces, and the number of Rectangular bearing modules for air diffusers (102) depend on the length of the electrochemical reactor (1), size, number of flexible thermo-perforated diffuser tubes (107) to diffuse the agitation air and the overall flow rate of aeration required in the interelectrode spaces to the inside the container (2) according to the range of current intensity operated in the electrochemical reactor (1).

34. Electrochemical method according to claim 32, CHARACTERIZED in that a flow of atmospheric diffusion air that feeds the self-supporting monolithic structural frame (101), first passes through a rotameter and pressure switch (110), and then optionally, through a device anti siphon (111) located in line with an anti return device (112), prior to entering through the air entry point (103) into the self-supporting monolithic structural frame (101), by means of a PVC tube of at least 10 inches diameter, externally reinforced by a continuous filament blanket (fiberglass and resin) encapsulated in the monolithic structural polymer mortar of the self-supporting monolithic structural frame (101), where the diffusion air flow is displaced by the self-supporting monolithic structural frame (101), which internally has T-junctions at the T-junction points (104), to supply air to each rectangular module carrying air diffusers (102), to through the power connection point (105).

35. Electrochemical method according to claim 32, CHARACTERIZED in that the coalescence is initiated in the superimposed perimeter mini-ventilated chambers (209) by the entry of controlled atmospheric air flow rates (210) that is at a lower temperature than the mini-ventilated chambers. superimposed perimeters (209), which initiates and enhances the growth of size and weight of the aerosols until they reach such a size that, by their own weight, they fall back into the electrolyte (5) that originated them, being continuously recycled at the same time as generated with the operation of the electrochemical reactor (1).

36. Electrochemical method according to claim 32, CHARACTERIZED because also the emerging flow on the liquid column (306) of the bubbler (305), always inside the DEVA acid vapor depurator (302), by means of a heat exchanger (307) and a refrigerant fluid cooled externally to the electrochemical reactor (1), from 1° to 5° C., either with a Vortex tube (501), or preferably with a Chiller cooler (308) for some liquid refrigerant (water, glycol or other), the aerosols and vapors of the gaseous fluid effluent from the bubbler (305) in the DEVA (302) are recovered substantially by condensation.

37. Electrochemical method according to claim 32, CHARACTERIZED because it also includes supplying external atmospheric air to the self-supporting monolithic structural framework (101), which enters through a rotameter and pressure switch (110) and optionally through a pipe that leads it through an anti-siphon device (111) in line with an anti-return device (112) of gaseous fluid, prior to its feeding at the air entry point (103) to the self-supporting monolithic structural frame (101); using a PVC tube of at least 10 inches in diameter externally reinforced by a bidirectional continuous filament blanket encapsulated in structural polymer mortar; the air flow travels through the self-supporting monolithic structural frame (101), which internally has T joints at the T connection points (104), to feed each rectangular module carrying air diffusers (102), through from the power connection point (105).

38. Electrochemical method according to claim 32, CHARACTERIZED because in addition the multiple superimposed parallel flexible longitudinal seals (207) closest on the electrolyte, with the sweep flow of the effluent ventilation air from the superimposed perimeter mini-ventilated chambers (209) prevents the sustained and necessary contact of the corrosive anions with the cathode plate (11) in the unit cells in the strip of cathode plates (11) that remains on the surface of the electrolyte (5) of the multiple superimposed parallel flexible longitudinal seal (207) bottom of the superimposed perimeter mini ventilated chamber (209) next to the electrolyte.

39. Electrochemical method according to claim 35, CHARACTERIZED in that the coalescence is promoted with the entry of controlled atmospheric air flow rates (210) sufficient to drag the confined acid mist under the multiple superimposed parallel flexible longitudinal seals (207) and then through the lateral channels (211) of the container (2) of the electrochemical reactor (1) to the point of extraction of the container (2) for depuration outside the container (2) of the vapors and aerosols in the DEVA acid vapor depurator (302).

40. Electrochemical method according to claim 39, CHARACTERIZED because the coalescence of mini droplets with continued growth in aerosol size that is initiated in the superimposed perimeter mini-ventilated chambers (209) by the entry of controlled atmospheric air flow rates (210) colder than the ambient temperature of the superimposed perimeter mini-ventilated chambers (209), the thermal differential enhances the growth in size of the aerosols until reaching such a size that, due to their own weight, they fall back to the electrolyte (5) where they originated, being continuously recycled at the same time that they are generated with the operation of the electrochemical reactor (1).

41. Electrochemical method according to claim 36, CHARACTERIZED in that the emergent flow on the liquid column (306) of the gaseous effluent bubbling fluid (305), always inside the DEVA acid vapor depurator (302), by means of an exchanger of heat (307), whereby the aerosols and vapors of the gaseous fluid effluent from the bubbler (305) are recovered substantially by condensation.

42. Electrochemical method according to claim 41, CHARACTERIZED in that the cooling of the effluent gaseous fluid extracted “cell by cell” (303) from the DEVA acid vapor depurator (302) to condense water vapor, recover sulfuric acid, and electrolyte sprays and incorporate them into the condensate of the DEVA acid vapor depurator (302) by feeding hyper cold air provided by a Vortex Tube device (501), or preferably with a Chiller cooler (308) for any liquid refrigerant (water, glycol or other), in two alternatives: (a) directly to the interior volume of the liquid column of the DEVA acid vapor depurator (302) that bubbles the gaseous fluid; (b) feeding the heat exchanger (307) and circulating the cooled hyper air to produce condensation of the flow of the gaseous effluent fluid extracted “cell by cell” (303); in both cases the flow of the hot effluent air (502) from the Vortex Tube (501) and the Air Amplifier (500) (if included), is used to dilute the level of contaminants remaining from the discharge of the harmless effluent gas fluid (304) of the DEVA acid vapor depurator (302) and air amplifier (500).
